(19) United States
(12) Patent Application Publication
(10) Pub. No.: US 2011/0035313 A1
(43) Pub. Date: Feb. 10, 2011

(54) American and European style Win, Lose or Draw derivative instruments

(76) Inventor: Bruce David Silverman, Minneapolis, MN (US)

Correspondence Address: Bruce David Silverman, Apt. 339, 7160 Cahill Rd., Minneapolis, MN, 55439, US

(21) Appl. No.: 12/925,260

(22) Filed: Oct. 18, 2010

Related U.S. Application Data
(63) Continuation-in-part of application No. 12/655,378, filed on Dec. 30, 2009.
Application No. 12/655,378 is a continuation-in-part of application No. 12/583,647, filed on Aug. 24, 2009.
Application No. 12/583,647 is a continuation-in-part of application No. 11/484,223, filed on Jul. 11, 2006, now Pat. No. 7,620,589.
(60) Provisional application No. 60/698,122, filed on Jul. 11, 2005.

(51) Int. Cl. G06Q 40/00

(52) U.S. Cl. 705/37

(57) ABSTRACT

Methods and systems are disclosed for listing and trading fixed-payoff derivative contracts between two parties based on the movement of an underlying financial instrument in a manner that eliminates the cost associated with a traditional option premium. The invention, henceforth referred to as a “Win, Lose or Draw” derivative contract, is a cash position for or against the occurrence of a designated price event above an underlying financial instrument's spot price before the occurrence of a designated price event below an underlying financial instrument's spot price, or vice versa, within a designated time period. If neither designated price event occurs within the designated time period, no loss of cash position is incurred by either party. Embodiments of the invention include both American-style and European-style contracts, the application of asset-backed contracts, transferable positions, multiple underlying financial instruments within the same contract, asymmetric time periods, and expirationless time periods.

### RELATED APPLICATIONS

The present application is a continuation-in-part of U.S. patent application Ser. No. 12/655,378, filed Dec. 30, 2009, which is a continuation-in-part of U.S. patent application Ser. No. 12/583,647, filed Aug. 24, 2009, which is a continuation-in-part of U.S. patent application Ser. No. 11/484,223, filed Jul. 11, 2006, now U.S. Pat. No. 7,620,589, which in turn claims the benefit of U.S. Provisional Patent Application No. 60/698,122, filed Jul. 11, 2005. Priority is claimed to all of the above cited applications, the disclosures of which are hereby incorporated by reference.

### FIELD OF THE INVENTION

This application relates generally to derivative instruments traded in a securities market; more particularly to a new form of securities derivative traded on a securities, commodities, options or futures exchange or other suitable market; and more particularly still to a derivative product that provides win, lose or draw scenarios that involve fixed cash or asset-backed positions and fixed payoffs based on the price movements of one or more underlying financial instruments.

### BACKGROUND OF THE INVENTION

The use of non-linear derivatives has become a widespread practice and vital tool in the markets over the last thirty years, ever since the Black-Scholes formula for calculating the price of options was introduced in 1973. As with all non-linear derivatives created since that time, one of the fundamental aspects to trading such financial instruments is the pricing of the option, or what is known as the “premium.” Many variations of the Black-Scholes formula have been proposed and implemented, particularly formula variations that take into account the aspects of American-style options. Furthermore, many variations of options derivatives have been devised, including exotic options of varying characteristics and parameters, such as binary options, barrier options, double barrier options and double barrier digital options. Regardless of the parameters of these derivatives, they are typically subject to a premium—the cost of the option—that is tied to an underlying financial instrument, be that underlying instrument related to equities, commodities, bonds or currencies. Indeed, there are even non-linear derivatives tied to linear derivatives in the form of options on futures.

Despite the fact that the various permutations of non-linear derivatives are largely designed as a hedging instrument for mitigating risk, the potential for sizable losses still exists if a non-linear derivative such as a so-called “plain vanilla option” expires “out of the money” and the entire cost of the premium is lost, or even when such an option expires “in the money” but the final value of the option is less than the original premium paid. In other words, if the performance of an underlying financial instrument does not meet an anticipated minimum criteria within a designated time frame, at least some portion of the cost of the option will be lost. Still, one of the reasons options offer so much appeal is because one will always know exactly the maximum amount of downside risk before taking a position—the cost of the premium—while the potential upside is theoretically limitless, at least in the case of plain vanilla Call options.

However, the gains that can be realized in an option position usually has a topside implied by the volatility of the underlying instrument. Furthermore, because a traditional option position is always at risk due to eroded time value and the volatility of the underlying, traders have devised elaborate hedging strategies such as “delta hedging” and other complex hedging strategies to mitigate the risk of lost value. In other words, traders hedge against hedging strategies, creating financial maneuvers that can become very intricate, confusing and speculatively hazardous.

These shortcomings of non-linear and exotic derivatives highlight the need for a simpler and safer approach to hedging, leveraging and speculating, where the volatility of an underlying financial instrument and time sensitivity of a derivative contract based on the underlying does not place the value of a position at as great a risk as currently manifested in prior art derivatives.

### SUMMARY OF THE INVENTION

The present invention offers a new approach to trading derivatives by introducing an instrument that eliminates the cost and risk associated with a premium. Just like existing derivatives, the new premium-free “Win, Lose or Draw” derivative contract is based on the speculative price movement of an underlying financial instrument within a designated period of time. But instead of offering the potential for incremental gains along with the right (but not the obligation) to purchase the underlying instrument at a specified price in exchange for a premium, the premium-free Win, Lose or Draw derivative contract applies an “implied probability” ratio, derived indirectly from the implied volatility of the underlying instrument, which determines the exact gain or loss that would be realized for any position should one specified price event occur before another specified event, and vice versa, with respect to an underlying financial instrument's spot price within a given time period. If neither specified price event occurs, neither position is lost and the individuals holding the positions will only incur the cost related to the execution of a transaction, for example, a broker's fee for executing a trade.

A loose correlation would be to consider the so-called “place number” wagers in the game of Craps. This is a wager that a given number will occur before another given number occurs in the roll of the dice, specifically, bets for or against the occurrence of the individual number values 4, 5, 6, 8, 9 and 10 before the occurrence of the number value 7, or vice versa. If a winning event occurs on any given roll of the dice, the wager is paid off according to the probability of a winning event occurring versus a losing event occurring, minus the casino's house edge. If a losing event occurs on any given roll of the dice, the wager is lost. If neither a winning event nor losing event occurs on any given roll of the dice, the wager is neither won nor lost.

In a Win, Lose or Draw derivative contract, two speculative price thresholds for an underlying financial instrument—one above and one below the spot price of an underlying financial instrument—are the winning and losing price events. If neither speculative price event occurs before or at a designated expiry, then a position is neither won nor lost.

However, unlike the game of Craps, where there are known probabilities based on 36 possible combinations for 11 possible outcomes, price events related to underlying financial instruments don't have inherent probabilities of occurrence. Instead, in order to calculate a position and potential payoff in a Win, Lose or Draw contract, one must consider the implied volatility of an underlying instrument at any given point in time to determine the implied probability of the underlying instrument reaching one speculative price above the spot price before reaching another speculative price below the spot price, and vice versa, within a given time frame. The ratio derived from the implied volatility of an underlying financial instrument with respect to the two speculative prices—one above and one below the spot price—is the implied probability ratio used to determine the payoff for a position in a Win, Lose or Draw contract.

Moreover, the application of implied probability to create win, lose or draw payout scenarios can be used to construct embodiments of the invention that reflect the parameters of either American-style or European-style derivatives. That is to say, in an American-style Win, Lose or Draw derivative contract, a winning or losing price event can be determined at any time within a predetermined time frame, while in a European-style Win, Lose or Draw derivative contract, a winning or losing price event can only be determined at expiry of the predetermined time frame. And in both American-style and European-style Win, Lose or Draw derivative contracts, a draw is determined at expiry.

In a preferred embodiment of the invention, a Win, Lose or Draw contract is executed as a “pure” derivative that is not tied to ownership of the underlying instrument, but rather, provides a cash-based contract that matches a party who believes that the underlying instrument will reach a designated price above the spot price before the underlying instrument reaches a designated price below the spot price with a party who believes that the underlying instrument will reach the designated price below the spot price before the underlying instrument reaches the designated price above the spot price, before or at expiration. However, this does not preclude the construction of asset-backed contracts, for example, where the two parties hold positions in the underlying financial instrument and some units of the underlying form the value of the two respective positions in the contract.

In additional embodiments of the invention, the contract can be constructed utilizing two or more underlyings, such that for each underlying there is a corresponding party taking the position that a price event relative to the spot price of that underlying will occur before any other price event relative to the spot prices of the other underlyings. Yet in additional embodiments of the invention, asymmetric time frames can be applied such that at least one price event in a contract is given a longer or shorter time period to occur. And still in additional embodiments of the invention, expirationless time periods can be applied such that a contract is not settled until one of the price events occurs.

### BRIEF DESCRIPTION OF THE DRAWINGS

FIG. 1 is a flow chart that depicts the general sequence of events for a computer-implemented method of trading a derivative product according to an embodiment of the present invention.

FIG. 2 is a flow chart that depicts the general sequence of events for a computer-implemented method of trading a derivative product according to an embodiment of the present invention.

FIG. 3 is a flow chart that depicts the general sequence of events for a computer-implemented method of trading a derivative product according to an embodiment of the present invention.

FIG. 4 is a flow chart that depicts the general sequence of events for a computer-implemented method of trading a derivative product according to an embodiment of the present invention.

FIG. 5 illustrates an example of a computer-implemented order-entry interface that can be utilized to place an order for a position in a contract specific to the present invention.

FIG. 6 depicts a programmed computer device that can be utilized to implement the various aspects and embodiments of the present invention.

FIG. 7 is a diagram that depicts a computerized system that can be utilized to facilitate a trade specific to the invention.

### DETAILED DESCRIPTION OF THE INVENTION

The present invention introduces a new type of derivative instrument, specifically, a derivative that does not require a position in the underlying financial instrument to which the derivative is tied, nor the payment of a premium for a position in the contract. Instead, the new, premium-free “Win, Lose or Draw” contract introduces the concept of “implied probability” for determining a reward ratio for one designated speculative price above a financial instrument's spot price occurring before another designated speculative price below the financial instrument's spot price, and vice versa, within a specified period of time. If neither speculative price event occurs within the specified period of time, neither party loses the value of their position.

In one embodiment of the invention, a cash-based Win, Lose or Draw contract would be tied to the spot price of a single underlying financial instrument, such as a common stock, an equity index listing such as the S&P 500, a mutual fund or exchange-traded fund (ETF), commodities futures such as corn or gold, a bond, an interest rate, a volatility index, or any currency. And the speculative price events above and below the spot price of the underlying can be based on preexisting out-of-the-money Call and Put strike prices. However, this does not preclude the use of dedicated target prices unrelated to preexisting strike prices.

The likelihood, that is, the implied probability of one speculative price event above the spot price of an underlying financial instrument occurring before the other speculative price event below the spot price, and vice versa, at any given point in time within the predetermined time frame is determined by considering the implied volatility of the underlying instrument as reflected by a metric such as option strike price premiums, where the premium for a Call strike price above the underlying instrument's spot price is compared to the premium for a Put strike price below the underlying instrument's spot price, and the comparison establishing the likelihood of one strike price—that is, one speculative price event—being realized before the other strike price—that is, the other speculative price event—before or at the expiration of the option period. This does not preclude the use of other metrics and mathematical models to establish an implied probability ratio that determines a cash or asset-backed position and potential return for a Win, Lose or Draw position. Such models can be as simple as the comparison of the distance of each of two Win, Lose or Draw target prices above and below an underlying's spot price from the spot price at any given point in time, or they can involve more intricate mathematics that take into account the underlying's history of upward volatility versus downward volatility, time to expiration and/or other deterministic and/or stochastic factors. Thus, for all disclosed embodiments of the invention, the models used to determine the implied probability ratio should not be construed in a limiting manner.

In order to determine the size of a position in a Win, Lose or Draw contract for each of two parties, either of which may or may not be a market maker or exchange specialist, the implied probability ratio can be applied to any number of factors. For example, a typical options position is based on the equivalent of 100 shares per contract multiplied by the cost of the premium per share for that option. The same metric can be applied to Win, Lose or Draws for establishing a cash position. This does not preclude the use of other metrics such as a standard contract size multiplier equal to a fixed dollar amount, such as $100 per contract.

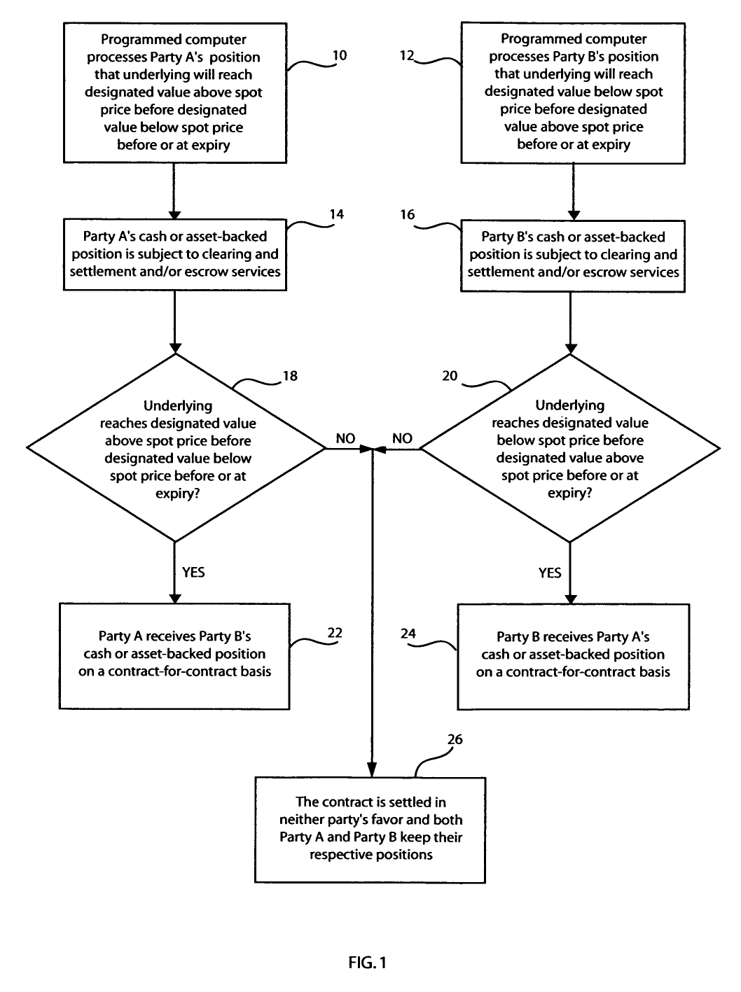

FIG. 1 represents the general sequence of events for trading a derivative product according to one embodiment of the invention, regardless of the metric used to determine the “implied probability” ratio, which in turn is applied to determine the size of a position and fixed return for either party. The computer-implemented sequence of events begins at step 10, where a programmed computer processes Party A's order for a cash position that the underlying will reach a designated value above the spot price before reaching a designated value below the spot price before or at expiry and at step 12, where a programmed computer processes Party B's order for a cash position that the underlying will reach the designated value below the spot price before reaching the designated value above the spot price before or at expiry. Party A's position is subject to clearing and settlement and/or escrow services at step 14 and Party B's position is subject to clearing and settlement and/or escrow services at step 16. At step 18, it is determined if the underlying reaches the designated value above the spot price before the designated value below the spot price before or at expiry or, conversely, at step 20, if the underlying reaches the designated value below the spot price before reaching the designated value above the spot price before or at expiry. If the underlying reaches the designated value above the spot price before the designated value below the spot price before or at expiry, then Party A receives Party B's position on a contract-for-contract basis at step 22. Conversely, if the underlying reaches the designated value below the spot price before reaching the designated value above the spot price before or at expiry, then Party B receives Party A's position on a contract-for-contract basis at step 24. If at steps 18 and 20, it is determined that the underlying reaches neither designated value above nor below the spot price before or at expiry, then the contract is settled in neither party's favor and both Party A and Party B keep their respective cash positions at step 26.

TABLE 1A below denotes symbols and formulas that can be used to determine the size and potential return for each position in a cash-based embodiment of the invention, where the metric used to determine the implied probability ratio, cash positions and fixed payoffs are strike prices and associated premiums for Calls and Puts above and below the spot price of a single underlying.

TABLE 1A

X = Spot Value of Underlying
S1 = Call Strike Price Above X
S2 = Put Strike Price Below X
P1 = S1 Premium
P2 = S2 Premium
F1 = P2 ÷ P1
F2 = P1 ÷ P2
D1 = P1 × 100 × # of contracts
D2 = P2 × 100 × # of contracts
S1 before S2 = (F1 × D1) + D1*
S2 before S1 = (F2 × D2) + D2*
*Total Return is the payoff realized on the position plus the original cash position.

In this application, where X denotes the underlying, the Call strike price above the spot price for the underlying, denoted by the symbol S1, has a corresponding premium denoted by the symbol P1, and the Put strike price below the spot price for the underlying, denoted by the symbol S2, has a corresponding premium denoted by the symbol P2.

Because the premiums for standard American and European options (often referred to as plain, vanilla options) reflect implied volatility for the underlying, one embodiment of the invention uses the values of the respective premiums (P1 and P2) specific to an underlying's spot price at any given point in time to establish an implied probability of a Call strike price above the underlying's spot price occurring before a Put strike price below the underlying's spot price and vice versa before or at a common expiry.

In one embodiment of the invention, an American-style Win, Lose or Draw derivative contract compares a Call strike price premium above the underlying's spot price with a Put strike price premium below the underlying's spot price, with the same expiration period, to determine the likelihood of one strike price occurring before the other strike price within the same expiration period. By using a Call strike price that is “out of the money” and a Put strike price that is out of the money as two respective target prices, one creates a reasonable, speculative scenario as to which direction an underlying instrument might move from a common starting point. And the comparison of the two strike price premiums relative to the spot price of the underlying at any given time determines the implied probability of one strike price being reached before the other strike price, and subsequently, the cash positions and potential, fixed payoff for each party that holds a position in a Win, Lose or Draw contract.

If one is taking a position that a designated Call strike price (S1) above the underlying's spot price will occur before a designated Put strike price (S2) below the underlying's spot price within the same designated time period, his cash position, represented by the symbol D1, would be the cost of the Call strike price premium (P1) multiplied by 100 multiplied by the number of contracts for his position. Conversely, if one is taking a position that a designated Put strike price (S2) below the underlying's spot price will occur before a designated Call strike price (S1) above the underlying's spot price within the same designated time period, his cash position, represented by the symbol D2, would be the cost of the Put strike price premium (P2) multiplied by 100 multiplied by the number of contracts for his position.

If the given underlying should reach the designated Call strike price before the designated Put strike price within the designated time period, the party that holds the Call position would receive a payoff based on the implied probability of the Call strike price being reached relative to the Put strike price being reached, where the factor (F1), by which his cash position (D1) would be multiplied to determine his payoff, would be the Put strike price premium (P2) divided by the Call strike price premium (P1). That payoff would then be added to his original cash position (D1), and the sum credited to his account, less any trade transaction fees.

Conversely, if the given underlying should reach the designated Put strike price before the designated Call strike price within the designated time period, the party that holds the Put position would receive a payoff based on the implied probability of the Put strike price being reached relative to the Call strike price being reached, where the factor (F2), by which he would multiply his cash position (D2) to determine his payoff, would be the Call strike price premium (P1) divided by the Put strike price premium (P2). That payoff would then be added to his original cash position (D2), and the sum credited to his account, less any trade transaction fees.

In other words, if the Call strike price is reached before the Put strike price, the party holding the Call position would receive the cash position for the party holding the Put position on a contract-for-contract basis. If the Put strike price is realized before the Call strike price, the party holding the Put position would receive the cash position of the party holding the Call position on a contract-for-contract basis. As stated earlier, if neither strike price is reached before or at expiry, no loss of cash position is incurred by either party.

The following example will help illustrate how one embodiment of a Win, Lose or Draw trade might transpire, using a hypothetical underlying and hypothetically available option strike prices and premiums as a metric for determining the implied probability ratio, which in turn is used to establish the cash positions and potential predetermined payoff for the two parties:

Suppose the underlying in question is the common stock for company XYZ. Company XYZ's stock price at a given point in time—the spot price—is $25 per share. At the same point in time, the June 30 Calls for XYZ have a premium of $1 per share and the June 22½ Puts have a premium of $2 per share. The implied volatility of the underlying as reflected by the premiums of the two strike prices suggest that within the same time period, the underlying stock price for XYZ is twice as likely to reach $22½ per share as $30 per share. Applying the basic probability principle that the true-odds payoff for one event occurring before another event is the probability of the losing event occurring divided by the probability of the winning event occurring, then the true-odds payoff for XYZ reaching $30 per share before $22½ per share is 2:1. Conversely the true-odds payoff for XYZ reaching $22½ per share before $30 per share is 1:2.

Continuing with the example, let's say that Party A assumes a one-contract Win, Lose or Draw cash position that the stock price for the underlying XYZ will reach $30 per share before reaching $22½ per share before or at the June expiry and Party B is willing to take the opposite position that the underlying XYZ will reach $22½ per share before reaching $30 per share before or at the June expiry. Party A's cash position, equivalent to 100 shares at a premium of $1 per share would be $100. Party B's cash position, equivalent to 100 shares at a premium of $2 per share would be $200. If the underlying reaches $30 per share before $22½ per share before or at the June expiry, Party A's payoff would be 2:1, or $200, which would be added to Party A's original $100 cash position for a total return of $300 that would be credited to Party A's account and Party B would lose his $200 cash position. Conversely, if the underlying reaches $22½ per share before $30 per share before or at the June expiry, Party B's payoff would be 1:2, or $100, which would be added to Party B's original $200 cash position for a total return of $300 that would be credited to Party B's account and Party A would lose his $100 cash position. If the underlying reaches neither $30 per share nor $22½ per share before or at the June expiry, Party A would keep his original $100 cash position and Party B would keep his original $200 cash position. It will be appreciated that the underlying's spot price and the strike price premiums can be based on last price, bid price, ask price or an average of bid and ask prices. It will also be appreciated that cash positions and total return figures exclude any trade transaction fees.

Using the example above, the figures for the symbols and formulas in Table 1A above would read as follows in Table 1B below:

TABLE 1B

X = $25
S1 = $30
S2 = $22½
P1 = $1
P2 = $2
F1 = 2
F2 = 0.5
D1 = $100
D2 = $200
$30 before $22½ (S1 before S2) = (F1 × D1) + D1 =
(2 × $100) + $100 = $300*
$22½ before $30 (S2 before S1) = (F2 × D2) + D2 =
(0.5 × $200) + $200 = $300*
*Total Return is the payoff realized on the position plus the original cash position.

In another embodiment of the invention which reflects the particular trading parameters of European-style options, Win, Lose or Draw contracts can be constructed and priced such that one price event above the spot price of an underlying financial instrument must occur at expiry of a predetermined time frame before another price event below the spot price of the underlying instrument occurs at expiry of a predetermined time frame, and vice versa. That is to say, in a European-style Win, Lose or Draw derivative contract, either one of two price thresholds above and below the spot price of a given underlying financial instrument must be breached at the end of a predetermined time frame to determine a winning and losing price event. And if neither price threshold is breached at expiry, the contract is a draw.

Just as with the aforementioned American-style example, a European-style Win, Lose or Draw derivative contract can employ the comparison of a Call strike price premium above the underlying's spot price with a Put strike price premium below the underlying's spot price, with a common expiration period, to determine the likelihood of one strike price being breached at expiry versus the other strike price being breached at expiry, and subsequently, the cash positions and potential, fixed payoff for each party that holds a position in a European-style Win, Lose or Draw contract.

Thus, using slightly modified hypothetical strike prices for European options, which are sometimes cheaper than American options, the symbols, formulas and figures in Tables 1A and 1B might translate as follows in Tables 1C and 1D below for a European-style contract:

TABLE 1C

X = Spot Value of Underlying
S1 = Call Strike Price Above X
S2 = Put Strike Price Below X
P1 = S1 Premium
P2 = S2 Premium
F1 = P2 ÷ P1
F2 = P1 ÷ P2
D1 = P1 × 100 × # of contracts
D2 = P2 × 100 × # of contracts
S1 at expiry before S2 at expiry = (F1 × D1) + D1*
S2 at expiry before S1 at expiry = (F2 × D2) + D2*

TABLE 1D

X = $25
S1 = $30
S2 = $22½
P1 = $.75
P2 = $1.50
F1 = 2
F2 = 0.5
D1 = $75
D2 = $150
$30 at expiry versus $22½ at expiry (S1 before S2) =
(F1 × D1) + D1 = (2 × $75) + $75 = $225*
$22½ at expiry versus $30 at expiry (S2 before S1) =
(F2 × D2) + D2 = (0.5 × $150) + $150 = $225*
*Total Return is the payoff realized on the position plus the original cash position.

In other words, by substituting European-style option strikes and prices for American-style option strikes and prices (which may or may not be the same), one can construct a Win, Lose or Draw scenario where the outcome of the contract can only be determined at the expiration of the contract period. Once again, this does not preclude the use of other metrics and mathematical models to establish an implied probability ratio that determines a position and potential return for a European-style Win, Lose or Draw contract position. Such models can be as simple as the comparison of the distance of each of two Win, Lose or Draw target prices above and below an underlying's spot price from the spot price at any given point in time, or they can involve more intricate mathematics that take into account the underlying's history of upward volatility versus downward volatility, time to expiration and/or other deterministic and/or stochastic factors.

European-style Win, Lose or Draw contracts can even be constructed that stipulate a range associated with the two positions such that the underlying must settle into either of two designated price ranges above and below the spot price at expiry to determine a winning and losing price event. In other words, in a “Double Range” Win, Lose or Draw derivative contract, the contract results in a draw if neither price range is satisfied at expiry.

In such a scenario, the symbols, formulas and figures in Tables 1C and 1D might translate as follows in Tables 1E and 1F below for a European-style contract with hypothetical winning and losing strike ranges:

TABLE 1E

X = Spot Value of Underlying
S1 = Strike Range Above X
S2 = Strike Range Below X
P1 = S1 Premium
P2 = S2 Premium
F1 = P2 ÷ P1
F2 = P1 ÷ P2
D1 = P1 × 100 × # of contracts
D2 = P2 × 100 × # of contracts
S1 at expiry before S2 at expiry = (F1 × D1) + D1*
S2 at expiry before S1 at expiry = (F2 × D2) + D2*

TABLE 1F
X = $25
S1 = $30 to $33
S2 = $22-1/2 to $21
P1 = $.75
P2 = $1.50
F1 = 2
F2 = 0.5
D1 = $75
D2 = $150
$30 to $33 at expiry versus $22-1/2 to $21 at expiry (S1 before S2) =
(F1 × D1) + D1 = (2 × $75) + $75 = $225*
$22-1/2 to $21 at expiry versus $30 to $33 at expiry (S2 before S1) =
(F2 × D2) + D2 = (0.5 × $150) + $150 = $225*
*Total Return is the payoff realized on the position plus the original cash position.

In the above example, a hypothetical proportionate range is used to demonstrate an equivalent payout ratio as the previous examples. It will be appreciated that “Single Range” Win, Lose or Draw derivative contracts can also be constructed such that the implied probability ratios are based on one price threshold being breached at expiry versus a price range being satisfied at expiry, with respect to an underlying's spot price.

It will be appreciated that the strike price premiums used to help determine position sizes, can be reduced or increased proportionally if the premiums are highly or fractionally priced. For example, if the strike price premiums for P1 and P2 in the previous example were $5 and $10 respectively, the premiums could also be expressed as $1 and $2. This can be achieved simply by dividing both premium prices by either the lesser or greater of the two. Conversely, premiums that are fractional can be multiplied by the lesser or greater premium's denominator. This serves the purpose of reducing or increasing a single contract to a more manageable and flexible size.

It will also be appreciated that the total potential return for either position in a Win, Lose or Draw contract, where strike price premiums are applied as a contract multiplier to help determine the contract sizes, can be expressed as being the same for either party on a contract-for-contract basis. This can be further demonstrated in Table 2 below by using the distributive property to show the two events “S1 before S2” and “S2 before S1” are both equal to 100N(P1+P2) where “N” is the number of contracts:

TABLE 2

| | |
|---|---|
| S1 before S2 | = (F1 × D1) + D1 |
| | = (P2/P1 × P1 × 100 × N) + (P1 × 100 × N) |
| | = (P2/ [symbol] × [symbol] × 100 × N) + (P1 × 100 × N) |
| | = (P2 × 100 × N) + (P1 × 100 × N) |
| | = 100N(P2 + P1) |
| S2 before S1 | = (F2 × D2) + D2 |
| | = (P1/P2 × P2 × 100 × N) + (P2 × 100 × N) |
| | = (P1/ [symbol] × [symbol] × 100 × N) + (P2 × 100 × N) |
| | = (P1 × 100 × N) + (P2 × 100 × N) |
| | = 100N(P1 + P2) |

It will also be appreciated that for all embodiments of the invention, a standard contract multiplier can be applied to establish a contract size, such as $100 per contract, to which the implied probability ratio would be applied to determine the potential payoff. Thus, on a trade involving a market maker who holds an inventory of contract positions and is equipped with sufficient capital, there is no particular need to use a strike price premium multiplier to establish a position equal to the counterparty's potential payoff.

Tables 3A and 3B illustrate such an embodiment where $100 is used as a flat rate multiplier per contract and the implied probability ratio is only applied to create the potential payoff for either position in a Win, Lose or Draw contract:

TABLE 3A

X = Spot Value of Underlying
S1 = Call Strike Price Above X
S2 = Put Strike Price Below X
P1 = S1 Premium
P2 = S2 Premium
F1 = P2 ÷ P1
F2 = P1 ÷ P2
D1 = 100 × # of contracts
D2 = 100 × # of contracts
S1 before S2 = (F1 × D1) + D1*
S2 before S1 = (F2 × D2) + D2*

TABLE 3B
X = $25
S1 = $30
S2 = $22-½
P1 = $1
P2 = $2
F1 = 2
F2 = 0.5
D1 = $100
D2 = $100
$30 before $22-½ (S1 before S2) = (F1 × D1) + D1 = (2 × $100) +
$100 = $300*
$22-½ before $30 (S2 before S1) = (F2 × D2) + D2 = (0.5 × $100) +
$100 = $150*
*Total Return is the payoff realized on the position plus the original cash position.

It will also be appreciated, that in a sufficiently liquid market, either party holding a position in a Win, Lose or Draw contract might choose to close out their position by selling their position to another party before expiry, as long as neither designated price event has occurred.

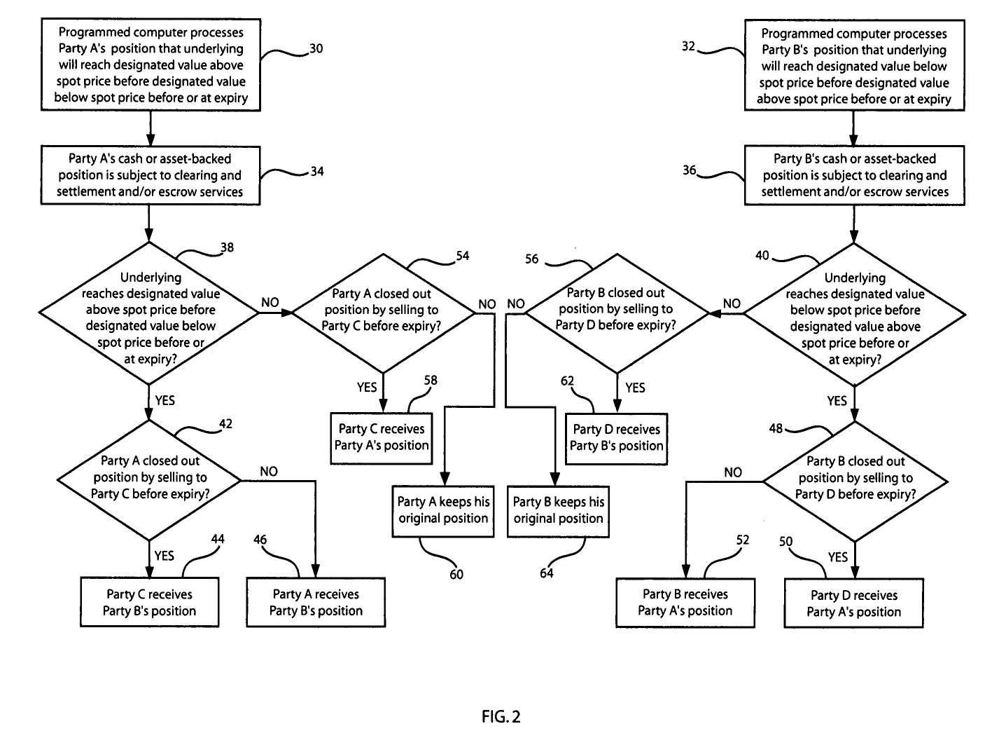

FIG. 2 represents the general sequence of events for trading a derivative product according to an embodiment of the invention in which the two original parties that hold a position in a Win, Lose or Draw contract have the option to close out their positions before expiry, essentially transferring ownership of their position. The computer-implemented sequence of events begins at step 30, where a programmed computer processes Party A's order for a cash position that the underlying will reach a designated value above the spot price before reaching a designated value below the spot price before or at expiry, and at step 32, where a programmed computer processes Party B's order for a cash position that the underlying will reach the designated value below the spot price before reaching the designated value above the spot price before or at expiry. Party A's position is subject to clearing and settlement and/or escrow services at step 34 and Party B's position is subject to clearing and settlement and/or escrow services at step 36. At step 38, it is determined if the underlying reaches the designated value above the spot price before the designated value below the spot price before or at expiry, and at step 40 it is determined if the underlying reaches the designated value below the spot price before reaching the designated value above the spot price before or at expiry. If the underlying reaches the designated value above the spot price before the designated value below the spot price before or at expiry, then at step 42 it is determined if Party A closed out his position by selling his position to Party C before expiry. If it is determined that Party A closed out his position to Party C at step 42, then Party C receives Party B's position at step 44. If it is determined that Party A did not close out his position at step 42, then Party A receives Party B's position at step 46. Conversely, if the underlying reaches the designated value below the spot price before the designated value above the spot price before or at expiry, then at step 48 it is determined if Party B closed out his position by selling his position to Party D before expiry. If it is determined that Party B closed out his position to Party D at step 48, then Party D receives Party A's position at step 50. If it is determined that Party B did not close out his position at step 48, then Party B receives Party A's position at step 52. If it is determined at step 38 and step 40 that the underlying reaches neither designated target value before or at expiry, then it is determined if either or both parties closed out their respective positions to Party C and Party D before expiry at step 54 and step 56. If at step 54, it is determined that Party A closed out his position to Party C, then Party C receives Party A's position at step 58. If at step 54 it is determined that Party A did not close out his position, then Party A keeps his original position at step 60. Likewise, if at step 56, it is determined that Party B closed out his position to Party D before expiry, then Party D receives Party B's position at step 62. If it is determined at step 56 that Party B did not close out his position, then Party B keeps his original position at step 64. It will be appreciated that the same sequence of events can take place over multiple transfers of ownership for a position in the contract.

Continuing with the cash-based, American-style example, suppose the spot price of company XYZ has moved upward from $25 per share at the time Party A and Party B initiated the contract to a current spot price of $28 per share within the same June expiration period. At the time the contract was created, the implied probability of the XYZ reaching $22½ per share was twice as great as XYZ reaching $30 per share. However, at this updated spot price with regard to the expiration period, the implied probability has changed so that it is now three times as likely for XYZ to reach $30 per share before or at expiry as it is to reach $22½ per share before or at expiry. So now if one were to take a position in a June Win, Lose or Draw contract where the spot price for XYZ is $28 per share, the following factors would determine the size of the position and potential return, where the premium on a June 30 XYZ Call is $1.50 and a June 22½ XYZ Put is $0.50.

Table 4 below denotes the updated values for the symbols and formulas from Table 1B when XYZ has a spot price of $28 per share within the same expiration period.

TABLE 4
X = $28
S1 = $30
S2 = $22-½
P1 = $1.50
P2 = $.50
F1 = .333
F2 = 3.0
D1 = $150
D2 = $50
$30 before $22-½ (S1 before S2) = (F1 × D1) + D1 = (.333 × $150) +
$150 = $200*
$22-½ before $30 (S2 before S1) = (F2 × D2) + D2 = (3.0 × $50) +
$50 = $200*
*Total Return is the payoff realized on the position plus the original cash position.

Suppose now, Party C comes along and wants to take a position that XYZ will reach $30 per share before $22½ per share before or at the June expiry when the spot price is $28 per share. He would have to put up $150 to receive a $50 payoff versus the $100 Party A paid for the contract to receive a $200 payoff on his $100 position. Suppose also, despite the current $28 spot price, Party A has some trepidation about the price of XYZ reaching $30 per share before expiry and wishes to sell (to close out) his position in exchange for locking in a profit. Meanwhile, Party C is convinced that XYZ will indeed reach $30 per share before expiry. But rather than open a new position with a 33% return ratio, Party C makes Party A an offer that is more advantageous than opening a new position. So Party C, who might be an individual trader or a market maker, offers to buy Party A's position for $200, ensuring Party A a $100 profit on his original $100 position. This proves advantageous for Party C as well should XYZ reach $30 per share before $22½ per share, because he will receive Party A's total return of $300 if XYZ reaches $30 per share before $22½ per share, thereby realizing a 50 percent return on his money rather than a 33 percent return on his money if he opened a new position at the current $28 spot price. On the other hand, if Party C buys Party A's position and XYZ does an about-face and reaches 22½ before 30 before expiry, Party A will have still realized a $100 profit (thanks to the $200 Party C paid directly to him), Party B receives a $300 total return (his original $200 position plus Party A's original $100 position), and Party C is out the $200 he paid directly to Party A. If neither price event occurs, Party C keeps Party A's original $100 cash position since he now owns Party A's position, and he assumes a $100 net loss since he paid Party A $200 for his $100 position. Suppose also, that at the $28 spot price, Party B is panicking because he's afraid that XYZ will reach $30 per share before expiry and he will lose his entire cash position. He doesn't want to lose his entire $200 position, so he tries to close out his position at a loss that is less than $200. Party D comes along and sees that at the current spot price of $28 per share, the June Win Lose or Draw contract position for $22½ per share occurring before $30 per share carries an implied probability of one in three and a payoff of 3:1. Party D, who also might be an individual trader or market maker, makes Party B an offer for his position that is more advantageous than opening a new position. He makes Party B an offer of $60 for his $200 position. Party B is very nervous and figures losing $140 is better than losing his entire $200 position and closes out his position to Party D. So now if the stock does an about-face and XYZ manages to reach $22½ per share before reaching $30 per share within the June expiration period, Party D will have paid $60 to receive a net return of $240 and a total return of $300 versus paying $50 to receive a net return of $150 and a total return of $200 if he opened a new position when XYZ was at $28 per share. This is equivalent to a 400% return on his cash outlay versus the 300% return if he were to open a new position with the spot price for XYZ at $28 per share. On the other hand, if XYZ does indeed climb to $30 per share first, then Party D will be out the $60 he paid for Party B's position. However, the good news for Party D is that if neither designated price event occurs by expiry, then he receives Party B's original $200 cash position since he now owns that contract position, netting him a gain of $140 . . . a 233% net return on the $60 he paid to purchase Party B's position in the contract. Once again, it will be appreciated that cash positions and total return figures exclude any trade transaction fees and that any number of metrics and mathematical models might be used to determine the implied probability ratio.

In another embodiment of the invention involving multiple underlyings, each of two or more designated price events can be tied to respectively different underlyings, where any given position in a Win, Lose or Draw contract is based on the occurrence of a given price event relative to the spot price of a given underlying before the occurrence of any one of one or more different price events relative to the spot price of their respective different underlyings. For example, a Win, Lose or Draw contract can comprise opposing positions that a first given underlying will reach a target price relative to the first given underlying's spot price before a second given underlying reaches a target price relative to the second given underlying's spot price, and vice versa, before expiry. This approach can be useful when hedging across different asset classes. For example, one might wish to hedge a portfolio predominantly composed of equities against the specter of inflation and a consequent drop in equity prices by taking a position that an inflation-sensitive asset, for example, an underlying gold instrument, will reach a certain price before an equity underlying reaches a certain price. If the underlying gold instrument reaches its given target price before the equity underlying reaches its given target price, the payoff is realized. If inflation remains tame, and the equity underlying's target price is reached first, the cash position is lost. If neither the gold nor the equity underlying reach their respective designated target prices before or at expiry, the contract is a draw and no loss of position is realized.

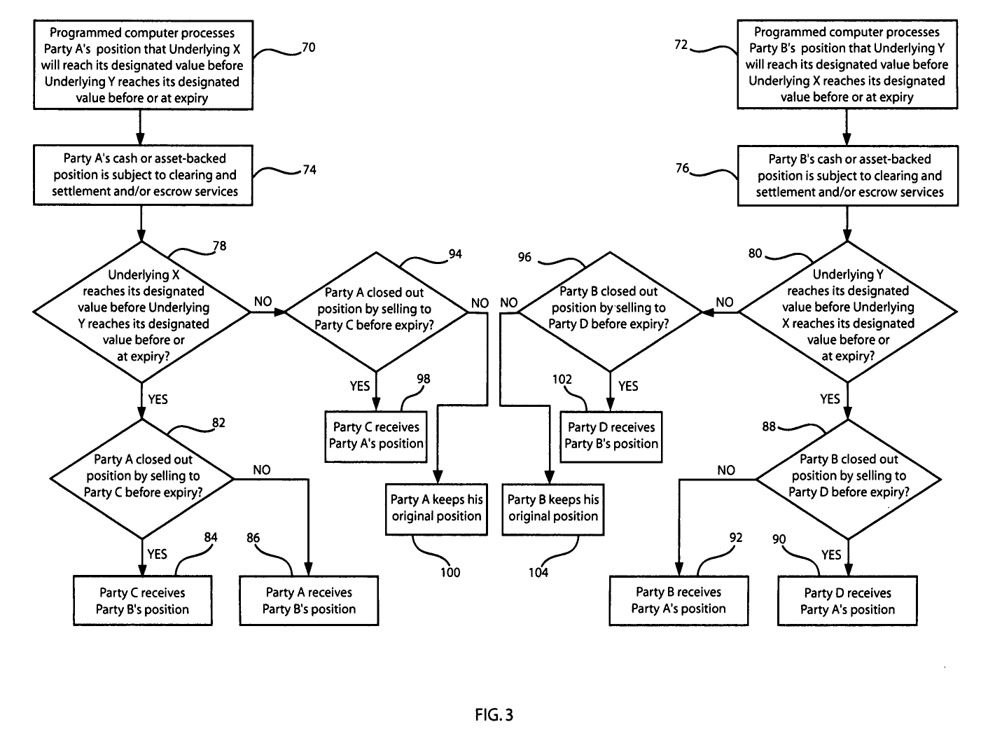

FIG. 3 represents the general sequence of events for trading a derivative product according to an embodiment of the invention in which the two speculative price events involve two different underlyings and where the two original parties that hold the position in the contract once again have the option to close out their positions before expiry, essentially transferring ownership of their position. The computer-implemented sequence of events begins at step 70, where a programmed computer processes Party A's order for a cash position that Underlying X will reach a designated value relative to its spot price before Underlying Y reaches a designated value relative to its spot price before or at expiry, and at step 72 where a programmed computer processes Party B's order for a cash position that Underlying Y will reach the designated value relative to its spot price before Underlying X reaches the designated value relative to its spot price before or at expiry. Party A's position is subject to clearing and settlement and/or escrow services at step 74 and Party B's position is subject to clearing and settlement and/or escrow services at step 76. At step 78, it is determined if Underlying X reaches its designated value before Underlying Y reaches its designated value before or at expiry, and at step 80 it is determined if Underlying Y reaches its designated value before Underlying X reaches its designated value before or at expiry. If it is determined that Underlying X reaches its designated value before Underlying Y reaches its designated value, then at step 82 it is determined if Party A closed out his position by selling his position to Party C before expiry. If it is determined that Party A closed out his position to Party C at step 82, then Party C receives Party B's position at step 84. If it is determined that Party A did not close out his position at step 82, then Party A receives Party B's position at step 86. Conversely, if it is determined that Underlying Y reaches its designated value before Underlying X reaches its the designated value, then at step 88 it is determined if Party B closed out his position by selling his position to Party D before expiry. If it is determined that Party B closed out his position to Party D at step 88, then Party D receives Party A's position at step 90. If it is determined that Party B did not close out his position at step 88, then Party B receives Party A's position at step 92. If it is determined at step 78 and step 80 that neither underlying reaches their respective designated values before or at expiry, then it is determined if either or both parties closed out their respective positions by selling them to Party C and Party D before expiry at step 94 and step 96. If at step 94, it is determined that Party A closed out his position to Party C, then Party C receives Party A's position at step 98. If at step 94 it is determined that Party A did not close out his position, then Party A keeps his original position at step 100. Likewise, if at step 96, it is determined that Party B closed out his position to Party D before expiry, then Party D receives Party B's position at step 102. If it is determined at step 96 that Party B did not close out his position, then Party B keeps his original position at step 104. It will be appreciated that the same sequence of events can take place over multiple transfers of ownership for a position in the contract.

TABLES 5A and 5B below denote symbols and formulas that can be used to determine the size and potential return for each position in a cash-based embodiment of the invention involving two underlyings.

TABLE 5A

X = Spot Value of Gold ETF
Y = Spot Value of Equity ETF
S1 = Strike Price Relative to X
S2 = Strike Price Relative to Y
P1 = S1 Premium
P2 = S2 Premium
F1 = P2 ÷ P1
F2 = P1 ÷ P2
D1 = P1 × 100 × # of contracts
D2 = P2 × 100 × # of contracts
S1 before S2 = (F1 × D1) + D1*
S2 before S1 = (F2 × D2) + D2*
*Total Return is the payoff realized on the position plus the original cash position.

TABLE 5B

X = $105
Y = $110
S1 = $120
S2 = $150
P1 = $2
P2 = $0.50
F1 = .25
F2 = 4
D1 = $200
D2 = $50
S1 before S2 = (.25 × $200) + $200 = $250*
S2 before S1 = (4 × $50) + $50 = $250*
*Total Return is the payoff realized on the position plus the original cash position.

In this example, let's suppose that X is the spot price for a gold ETF (Exchanged Traded Fund) trading at $105 per share and Y is the spot price for an S&P 500 ETF trading at $110 per share and that the premiums for the June 120 Gold ETF and June 150 S&P 500 ETF strike prices are $2 per share and $0.50 per share. By comparing the premiums for the respective strike prices for the same time frame, one can follow the calculations in Tables 5A and 5B above to ascertain the cash positions and potential returns on a contract for contract basis for two parties taking the opposite positions on which price event will occur first, with no loss of position by either party if neither price event occurs before or at expiry. It will be appreciated that cash positions and total return figures exclude any trade transaction fees. It will also be appreciated that as long as the strike price premiums for the different underlyings have the same expiration period, a reasonable metric might be established on which to base an implied probability ratio for one strike price occurring before the other. But of course, just as in the various other embodiments of the invention, any number of mathematical metrics can be used to determine the implied probability ratio.

Embodiments of the invention can even involve three or more underlyings, in which case the contract can be constructed to comprise a win, lose or draw scenario involving three or more parties where any given target price associated with its given underlying must be reached before any one of the two or more other target prices associated with their corresponding underlyings in order for a payoff to be realized. Accordingly, in such scenarios, if none of the target prices are reached before or at expiry, then the contact is settled in no party's favor and no loss of cash position would be incurred by any party.

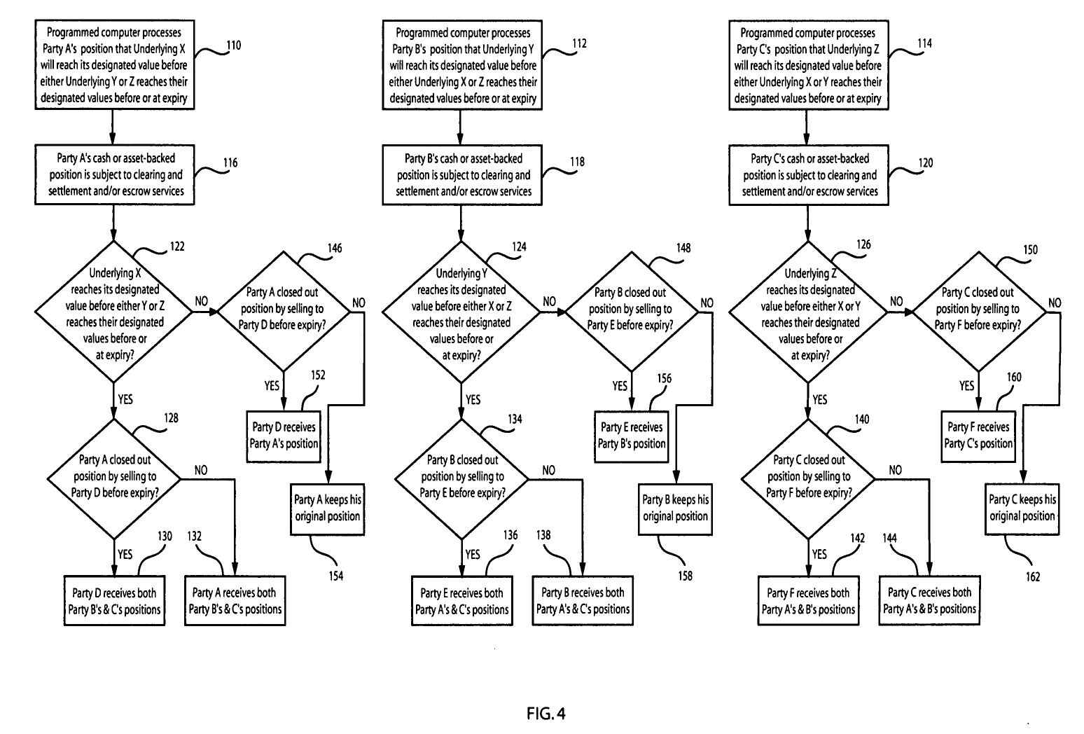

FIG. 4 represents the general sequence of events for trading a derivative product according to one embodiment of the invention in which three parties hold respective positions involving three different underlyings, each with a corresponding designated price event, and where the three original parties that hold the positions in the contract once again have the option to close out their positions before expiry as long as none of the three price events have occurred. The computer-implemented sequence of events begins at step 110, where a programmed computer processes Party A's order for a cash position that Underlying X will reach its designated value relative to its spot price before either Underlying Y or Underlying Z reaches their designated values relative to their spot prices before or at expiry. At step 112, a programmed computer processes Party B's order for a cash position that Underlying Y will reach its designated value relative to its spot price before either Underlying X or Underlying Z reaches their designated values relative to their spot prices before or at expiry. And at step 114, a programmed computer processes Party C's order for a cash position that Underlying Z will reach its designated value relative to its spot price before either Underlying X or Underlying Y reaches their designated values relative to their spot prices before or at expiry. Party A's position is subject to clearing and settlement and/or escrow services at step 116, Party B's position is subject to clearing and settlement and/or escrow services at step 118 and Party C's position is subject to clearing and settlement and/or escrow services at step 120. At step 122, it is determined if Underlying X reaches its designated value before either Underlying Y or Underlying Z reaches their designated values before or at expiry. At step 124 it is determined if Underlying Y reaches its designated value before either Underlying X or Underlying Z reaches their designated values before or at expiry. And at step 126, it is determined if Underlying Z reaches its designated value before either Underlying X or Underlying Y reaches their designated values before or at expiry. If Underlying X reaches its designated value first, then at step 128 it is determined if Party A closed out his position by selling his position to Party D before expiry. If it is determined that Party A closed out his position to Party D at step 128, then Party D receives both Party B's and C's positions at step 130. If it is determined that Party A did not close out his position at step 128, then Party A receives both Party B's and C's positions at step 132. On the other hand, if Underlying Y reaches its designated value first, then at step 134 it is determined if Party B closed out his position by selling his position to Party E before expiry. If it is determined that Party B closed out his position to Party E at step 134, then Party E receives both Party A's and C's positions at step 136. If it is determined that Party B did not close out his position at step 134, then Party B receives both Party A's and C's positions at step 138. And if Underlying Z reaches its designated value first, then at step 140 it is determined if Party C closed out his position by selling his position to Party F before expiry. If it is determined that Party C closed out his position to Party F at step 140, then Party F receives both Party A's and B's positions at step 142. If it is determined that Party C did not close out his position at step 140, then Party C receives both Party A's and B's positions at step 144. If it is determined at step 122, 124 and 126 that none of the underlyings reach their respective designated values before or at expiry, then it is determined if any of the parties closed out their respective positions by selling them to Party D, E or F before expiry at step 146, 148 and 150. If at step 146, it is determined that Party A closed out his position to Party D, then Party D receives Party A's position at step 152. If at step 146 it is determined that Party A did not close out his position, then Party A keeps his original position at step 154. If at step 148, it is determined that Party B closed out his position to Party E before expiry, then Party E receives Party B's position at step 156. If it is determined at step 148 that Party B did not close out his position, then Party B keeps his original position at step 158. And if at step 150, it is determined that Party C closed out his position to Party F before expiry, then Party F receives Party C's position at step 160. If it is determined at step 150 that Party C did not close out his position, then Party C keeps his original position at step 162. It will be appreciated that the same sequence of events can take place over multiple transfers of ownership for a position in the contract.

TABLES 6A and 6B below denote symbols and formulas that can be used to determine the size and potential return for each position in a cash-based embodiment of the invention involving three or more underlyings.

TABLE 6A

X = Spot Value of Gold ETF
Y = Spot Value of Equity ETF
Z = Spot Value of Dollar ETF
S1 = Strike Price Relative to X
S2 = Strike Price Relative to Y
S3 = Strike Price Relative to Z
P1 = S1 Premium
P2 = S2 Premium
P3 = S3 Premium
F1 = (P2 + P3) ÷ P1
F2 = (P1 + P3) ÷ P2
F3 = (P1 + P2) ÷ P3
D1 = P1 × 100 × # of contracts
D2 = P2 × 100 × # of contracts
D3 = P3 × 100 × # of contracts
S1 before S2 or S3 = (F1 × D1) + D1*
S2 before S1 or S3 = (F2 × D2) + D2*
S3 before S1 or S2 = (F3 × D3) + D3*
*Total Return is the payoff realized on the position plus the original cash position.

TABLE 6B

X = $105
Y = $110
Z = $25
S1 = $120
S2 = $150
S3 = $22
P1 = $2
P2 = $0.50
P3 = $1
F1 = .75
F2 = 6
F3 = 2.5
D1 = $200
D2 = $50
D3 = $100
S1 before S2 or S3 = (.75 × $200) + $200 = $350*
S2 before S1 or S3 = (6 × $50) + $50 = $350*
S3 before S1 or S2 = (2.5 × $100) + $100 = $350*
*Total Return is the payoff realized on the position plus the original cash position.

In the above example, let's suppose that another asset class is added to the previous scenario, such as the US Dollar as measured against foreign currencies in the form of an ETF. In this scenario, X is once again the spot price for a gold ETF trading at $105 per share, Y is the spot price for an S&P 500 ETF trading at $110 per share and Z is the spot price for a US Dollar ETF trading at $25 per share. Party A is taking the position that the Gold ETF will rise to $120 before either the S&P 500 ETF rises to $150 or the US Dollar ETF falls to $22, Party B is taking the position that the S&P 500 ETF will rise to $150 before either the Gold ETF rises to $120 or the US Dollar ETF falls to $22, and Party C is taking the position that the US Dollar ETF will fall to $22 before either the Gold ETF rises to $120 or the S&P 500 ETF rises to $150. The designated price events for X, Y and Z (the strike prices 120, 150 and 22 respectively) have corresponding premiums for a June expiration period of $2, $0.50 and $1 respectively. By comparing the premiums for the respective strike prices for the same time frame, one can follow the calculations in Tables 6A and 6B to ascertain the cash positions and potential returns on a contract for contract basis for each of the three parties taking a position on which price event will occur first, with no loss of position by any party if none of the price events occurs before or at expiry. Here again, it will be appreciated that as long as the strike price premiums for the designated price events of the different underlyings are compared for a common time frame, a reasonable metric might be established on which to base an implied probability ratio for each price event occurring before the other two price events. But of course, just as in the various other embodiments of the invention, any number of mathematical metrics can be used to determine the implied probability ratio.

In yet another embodiment of the invention, which is asset-backed instead of cash-based, a position in a Win, Lose or Draw contract can consist of shares of the underlying rather than cash. In such an embodiment, the spot price of the underlying at the time of the contract can be multiplied by a standardized number of shares or units per contract and then that value applied to an implied probability factor to determine the respective positions. However, in this scenario, because D1 and D2 represent the positions of the respective parties in shares or units of an underlying, it will be appreciated that the designated target prices at which the contract would be won or lost must also be taken into consideration in determining the size and potential return of the respective positions. That is, once an implied probability factor is applied to the spot price and contract size as a base for determining the dollar value equivalent of a position, it must be divided by the share price at which the counterparty would win the contract to determine the true-odds, dollar-to-share equivalent position of a party and subsequent potential payoff for the counterparty relative to the spot price of the underlying at the time the contract was created. Returning to the original scenario where Party A is taking the position that company XYZ's stock price will reach $30 per share before $22½ per share before or at the June expiry at a spot price of $25 per share, and Party B is taking the opposite position, one embodiment outlines an asset-backed contract in shares that would be calculated as such in Table 7A and Table 7B below:

TABLE 7A

X = Spot Value of Underlying
S1 = Call Strike Price Above X
S2 = Put Strike Price Below X
P1 = S1 Premium
P2 = S2 Premium
D1 = P1 × X (spot price) × 100 shares × # of contracts ÷ S2
D2 = P2 × X (spot price) × 100 shares × # of contracts ÷ S1
S1 before S2 = D2 + D1**
S2 before S1 = D1 + D2**

TABLE 7B

X = $25
S1 = $30
S2 = $22-1/2
P1 = $1
P2 = $2
D1 = 1 × $25 × 100 shares ÷ 22.5 = 111.11 shares of XYZ
D2 = 2 × $25 × 100 shares ÷ 30 = 166.66 shares of XYZ
$30 before $22-1/2 (S1 before S2) = D2 + D1 = 277.78 shares**
$22-1/2 before $30 (S2 before S1) = D1 + D2 = 277.78 shares**
**Total Return is the return on the position plus the Party's original position, in shares.

In the above scenario, with company XYZ having a spot price of $25 per share and 100 shares of XYZ as the metric determining the size of a contract, then if XYZ were to reach $30 before 22½ before expiry, Party A would receive Party B's 166.66 shares plus his own original position of 111.11 shares for a total return of 277.78 shares. Conversely, if XYZ reached $22½ before $30, then Party B would receive Party A's 111.11 shares plus his own original 166.66 shares for a total return of 277.78 shares. It will be appreciated that in such an embodiment, fractional shares can be settled on a cash basis. Additionally, it will be appreciated that a combination of shares and cash can be used to establish a position if a party does not have a sufficient number of shares to cover the entire size of his position.

In yet another embodiment of the invention that can be applied to scenarios involving one underlying as well as multiple underlyings, asymmetric time frames, where at least one designated price event in the contract is assigned a longer or shorter time frame than at least one other price event, can be applied to formulate an implied probability ratio that would increase or decrease the payout ratio for at least one party as compared with a scenario based on price events with a common time frame.

For example, returning to the original scenario where Party A is taking the position that company XYZ's stock price will reach $30 per share before $22½ per share when XYZ is at $25 per share, and Party B is taking the opposite position, suppose the $22½ per share target price is still given a June expiration but the $30 per share target price is given an August expiration. In such a scenario, the $30 target price would have a significantly higher premium than a June expiration and the implied probability ratio would be changed to reflect the time period bias. So, where the original scenario outlined in Tables 1A & 1B demonstrates a likelihood twice as great for $22½ per share being reached before $30 per share, an asymmetric time frame applied to the scenario as described above might change the likelihood to even money since $30 per share is given a longer time frame to occur.

Applying the asymmetric time frames described above to the symbols and formulas in Tables 1A and 1B would read as follows in Tables 8A and 8B below:

TABLE 8A

X = Spot Value of Underlying
S1 = August Call Strike Price Above X
S2 = June Put Strike Price Below X
P1 = S1 Premium
P2 = S2 Premium
F1 = P2 ÷ P1
F2 = P1 ÷ P2
D1 = P1 × 100 × # of contracts
D2 = P2 × 100 × # of contracts
S1 before S2 = (F1 × D1) + D1*
S2 before S1 = (F2 × D2) + D2*

TABLE 8B
X = $25
S1 = $30
S2 = $22-½
P1 = $2
P2 = $2
F1 = 1
F2 = 1
D1 = $200
D2 = $200
$30 before or at August expiry before $22-½ before or at June expiry
(S1 before S2) = (F1 × D1) + D1 = (1 × $200) + $200 = $400*
$22-½ before or at June expiry before $30 before or at August expiry
(S2 before S1) = (F2 × D2) + D2 = (1 × $200) + $200 = $400*
*Total Return is the payoff realized on the position plus the original cash position.

Comparing Table 8B with Table 1B, where there was a common June expiry, a scenario has been created where the likelihood of either price being reached before the other has now become an even-money proposition since the scenario provides a longer period of time for the price event that is farther away from the spot price to occur. In such a scenario, if XYZ reaches either $30 per share or $22½ per share by the June expiry, then the contract would be settled accordingly on an even-money basis. If neither price has been reached by June expiry, then both parties must wait till the August expiry to see if $30 per share is reached, in which case the contract would be settled in Party A's favor. Should $22½ per share be reached between the June and August experies, the contract would not be settled in Party B's favor since $22½ per share only had until the June expiry to be reached. And if neither price event occurs by the August expiry, then the contract is settled in neither party's favor.

Asymmetric time frames can also be applied to European-style Win, Lose or Draw derivative contracts. Such a scenario would be defined as a price event above the spot price of a given underlying occurring at the expiration of a first time frame before a price event below the spot price of the given underlying occurring at the expiration of a second time frame, and vice versa.

Thus, using slightly modified hypothetical strike prices for European options, which are sometimes cheaper than American options, the symbols, formulas and figures in Table 8B might translate as follows in Table 8C below for a European-style contract with asymmetric time frames:

TABLE 8C
X = $25
S1 = $30
S2 = $22-½
P1 = $1.5
P2 = $1.5
F1 = 1
F2 = 1
D1 = $150
D2 = $150
$30 at August expiry versus $22-½ at June expiry (S1 before S2) =
(F1 × D1) + D1 = (1 × $150) + $150 = $300*
$22-½ at June expiry versus $30 at August expiry (S2 before S1) =
(F2 × D2) + D2 = (1 × $150) + $150 = $300*
*Total Return is the payoff realized on the position plus the original cash position.

Comparing the American-style asymmetric scenario in Table 8B with the European-style asymmetric scenario in 8C, either the $22½ threshold would have to be breached at the June expiry or the $30 threshold would have to be breached at the August expiry if the $22½ threshold was not breached at the June expiry in order for a winning and losing event to be determined. If neither threshold is breached at the end of their respective expiration periods, then the contract is a draw.

Indeed, asymmetric time frames can even be applied to European-style Win, Lose or Draw contracts with multiple underlyings and corresponding positions as long as the time frames are all different (to ensure two positions do not breach their thresholds at the end of the same expiry).

In yet another embodiment of the invention, a sufficiently liquid market would accommodate an American-style Win, Lose or Draw contract where the predetermined time frame is essentially expirationless. That is, by using mathematical models that take into account various deterministic and/or stochastic factors to formulate an implied probability of one designated price event occurring before one or more different designated price events with respect to the spot prices of one or more corresponding underlyings on an expirationless basis, a reasonably liquid market would allow two or more parties to hold on to their respective positions indefinitely until one of the designated price events occurs or allow them to close out their positions by selling them to other parties as long as none of the designated price events has occurred. In other words, in an expirationless Win, Lose or Draw contract, any given party's position would remain active until any one of the designated price events occurred or the party closed out his position.

As stated earlier, the various embodiments of the invention can be applied to any financial instrument with listed options. Additionally, dedicated Win, Lose or Draw probability tables based on dedicated target prices unrelated to preexisting option strike prices can be calculated and listed for any given underlying financial instrument, either as a dedicated tool for creating a liquid market in Win, Lose or Draw contracts or strictly for those underlying financial instruments that do not carry traditionally listed options.

It is also to be understood that within the context of the present invention, the spot price of any given underlying financial instrument may be defined as the current market price or any suitable quoted or posted price for the underlying financial instrument at any given point in time. Accordingly, the spot price may be defined as a bid, ask, last price traded, average of bid and ask price or any price that can be used as a suitable reference price for a given underlying in relation to one or more designated price events for the given underlying. Additionally, the spot price may be defined within the context of a contingent price, thereby accommodating trading methods well known to those skilled in the art, such as “knock-in” parameters.

Furthermore, it will be appreciated that the designated price events may be defined within the context of certain preconditions, for example, a “settlement price” for the underlying financial instrument for any given trading day or even a “settlement index” that employs a volume-weighted average of trade prices. Further still, it will be appreciated that a designated price event specific to the invention implicitly may be defined as a threshold price such that a designated price event comprises the occurrence of an exact price or any price beyond the exact price with respect to a reference price.

Additionally, for embodiments of the invention that apply strike price premiums for determining the implied probability ratio for one price event occurring before another, and vice versa, the premiums may be based on the current market price of the premiums or any suitable quoted or posted price for the premiums at any given point in time.

It will also be appreciated that the predetermined time frames for designated price events to occur inherently may be defined such that the price events may occur anytime during normal trading hours or only as official closing prices for any given trading day. The designated time frames may even be limited to a specific time frame within any given trading day, for example, the last hour of trading or during pre-market or extended hours trading.

It will also be appreciated, that while many mathematical models and metrics can be used by traders and market makers to derive an implied probability ratio for a scenario specific to the invention, just as with other traditionally listed financial instruments, a bid/ask quotation system will ultimately be the deciding factor for determining the positions and payoffs in a Win, Lose or Draw contract.

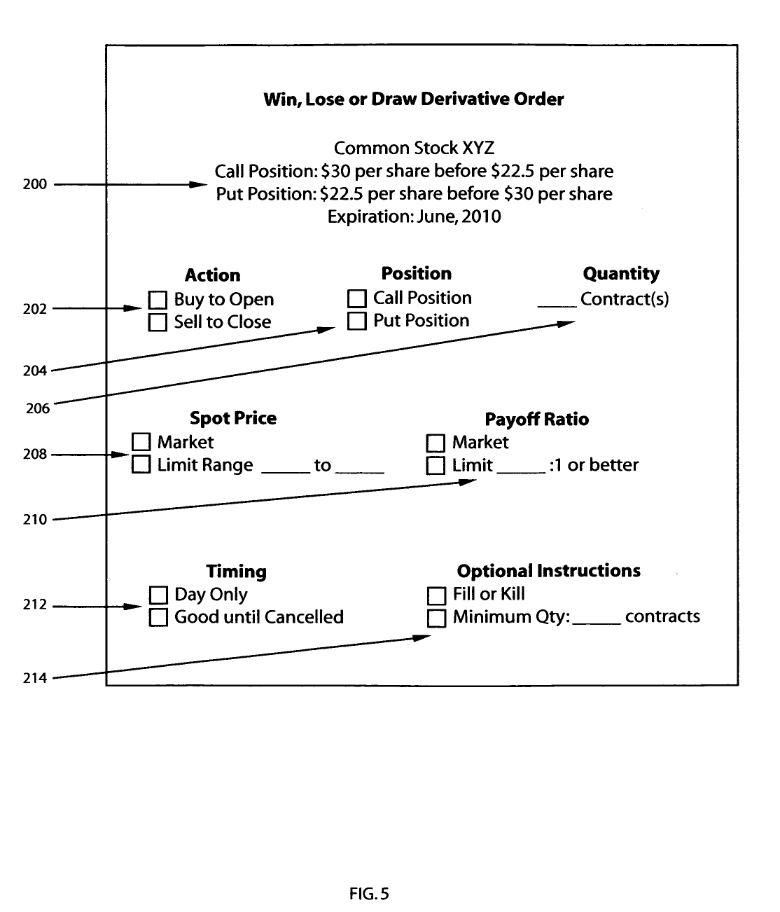

FIG. 5 illustrates one example of a computer-implemented order entry interface with flexible bid/ask defining parameters for placing an order for a position in a derivative contract specific to the invention and includes information that defines the speculative scenario for the underlying financial instrument 200 as well as fields for specifying the action to be taken by the trader 202, the position within the derivative contract to be taken by the trader 204, the quantity of contracts the trader wishes to place an order for 206, the underlying's price at which the trader wishes to engage in the contract 208, the payoff ratio that the trader would like to realize on a successful trade 210, the time duration for the order 212 and optional parameters concerning the placement of the order 214. In the above example, the trader can choose a contingent spot price for the underlying in field 208 as well as the payoff ratio he wishes to realize in field 210 for a position to be executed at that contingent spot price. Of course, it also allows for placing a market order for both parameters, in which case the order would be entered at the current spot price and payoff ratio that is offered for the speculative scenario. So, for example, if Party A wants to place an order for a Win, Lose or Draw contract Call position that pays 2:1 if XYZ reaches $30 per share before $22½ per share with a June expiration when the current market price of the underlying is $25 per share, but the best current offer is only 1.75:1, Party A can place a limit order for the position with regard to the spot price and payoff ratio by filling out the limit parameters in those fields. It will be appreciated while the aforementioned example provides flexible parameters around which a Win, Lose or Draw derivative contract order can be constructed, the example should not be construed in a limiting manner. It will also be appreciated that the information that defines the speculative scenario for the contract 200 and corresponding fields that define the contract order parameters can be easily modified to accommodate European-style embodiments of the invention as well as embodiments with asymmetric time frames, multiple underlyings and expirationless time frames.

Those skilled in the art will recognize that the computer hardware and software infrastructure required to implement a product specific to the invention can easily be adapted from technology already widely in use. Furthermore, those skilled in the art will recognize that the legal and logistical requirements for establishing, issuing, listing and trading a new type of derivative on the various exchanges are also well understood.

Computer programs embodied in a computer-readable medium, for executing instructions on one or more processors, can instantly calculate Win, Lose or Draw contracts based on any number of varying metrics that determine the size and potential return of the respective positions in a contract, thereby allowing traders to determine exactly what they would stand to gain or lose from a position in a contract at any point in time and place trades accordingly.

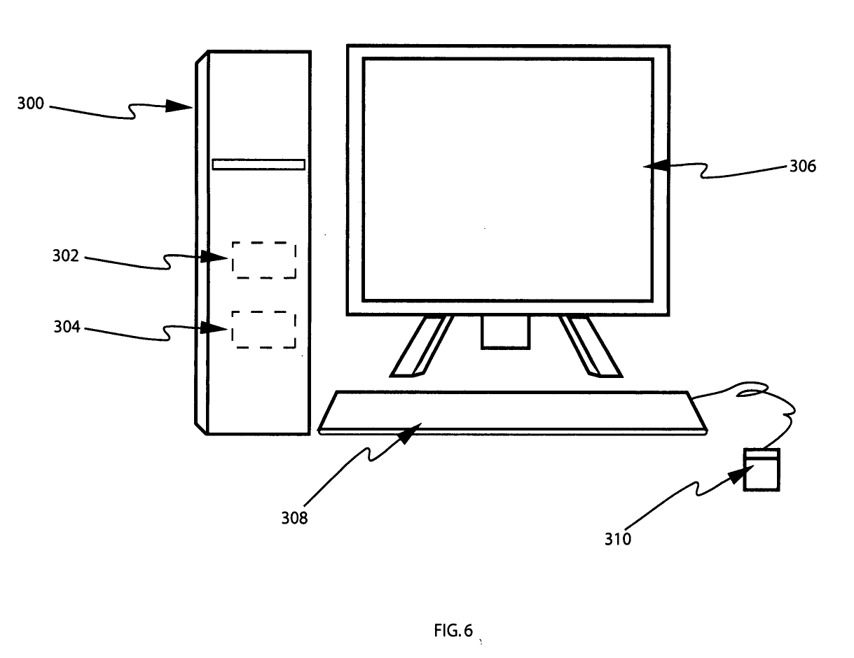

FIG. 6 is an example of a programmed computer device that can be utilized to implement various aspects and embodiments of the invention, said device comprising the aforementioned hardware and software including at least a physical housing 300, at least one computer processor 302, random access memory 304 that can utilize computer program products for executing instructions on the at least one processor, electronic monitor 306 on which to display relevant information specific to the invention, as well as a keyboard 308 and mouse device 310 for retrieving and inputting information in order to assist in executing a trade specific to the invention.

While the aforementioned apparatus describes a suitable device that can be used to implement various aspects and embodiments of the invention, it will be appreciated that any computerized device or computerized system comprising one or more computerized devices having adequate hardware and software capabilities may be used to implement the various aspects and embodiments of the invention.

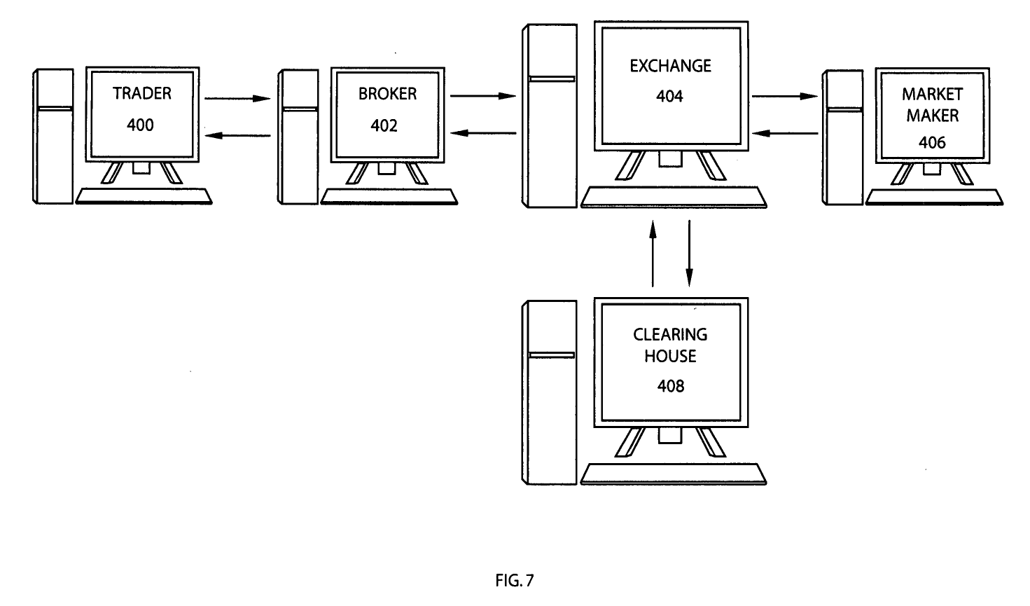

FIG. 7 depicts a computerized system comprising multiple computerized devices to facilitate a trade specific to the invention and illustrates a trader 400 communicating an order request to a broker 402 which forwards the order request to an exchange 404, which in turn may utilize the services of a market maker or exchange specialist 406 as a counterparty to the trade, and which upon a confirmed viable trade, subjects the trade to the services of a clearing house operation 408. This does not preclude the implementation of additional or alternate sequence steps to execute a derivative order specific to the invention and thus should not be construed in a limiting manner.

The aforementioned systems and mechanisms may also utilize electronic trading software and various software modules well know to those skilled in the art for the processing and execution of derivative orders at the brokerage and exchange level, including account data modules, market data modules, order book modules, match engine modules and order processing modules. Additionally, software programs implemented by clearing house services can provide the necessary compliance and settlement of a Win, Lose or Draw contract. Alternatively, or in concert with said brokerage houses, exchanges and clearing houses, software programs implemented by escrow services can record cash or asset-backed positions for Win Lose or Draw contracts and/or hold cash or asset-backed positions in an escrow account until the outcome of a contract is determined. This does not preclude the use of additional software programs and modules to implement and execute a derivative contract specific to the invention.

Those skilled in the art will also recognize the aforementioned systems and mechanisms may comprise the participation of one or more traders in concert with one or more brokerage houses, exchanges, clearing houses and market makers to execute a derivative contract specific to the invention. Furthermore, these systems and mechanisms may employ any of the numerous communications networks well known to those skilled in the art that enable traders, brokers and exchanges to interface with one another, including, but not limited to the Internet, intranets, wired and wireless Local Area Networks, Wide Area Networks, land-line based telephone networks and cellular telephone networks.

It will also be appreciated that the aforementioned systems and mechanisms may be applied to over-the-counter trading platforms in addition to exchange-traded platforms.

The advantages of the various embodiments of the present invention are manifold. As stated earlier, taking a position in a Win, Lose or Draw contract as opposed to buying a traditional option Call or Put eliminates the risk of a position decreasing in value or expiring worthless if the performance of the underlying financial instrument comes up short of expectations. This in turn reduces the need for elaborate hedging strategies because a Win, Lose a Draw contract reduces the risk associated with an option's eroded time value and the constant fluctuations in the price of the underlying.

Furthermore, it also provides an excellent method of hedging against a long or short position in an underlying instrument without having to write a Covered Call or Put and risk having a position in the underlying asset called away.

Additionally, it provides a win, lose or draw situation for volatile and short-term speculative market environments with the confidence of knowing that if an anticipated move in a given direction for an underlying is correct but comes up short of expectations, one would not lose any of his position, aside from the transaction fee.

Moreover, the invention can provide unique methods of speculating and hedging based on a laddering approach to designated price events. For example, a party can assume multiple positions comprising the occurrence of progressively higher price events above an underlying's spot price before the occurrence of a price event below an underlying's spot price, or vice versa, within the same time period or spread out over increasingly longer time periods. Additionally, these multiple positions can be bundled into a single trade transaction. To this effect, a single Win, Lose or Draw contract can be constructed to provide the potential for multiple payoffs over time, assuming the absence of the occurrence of a losing price event.

Another application would be to employ dynamic hedging techniques utilizing a contract position specific to the invention, where, for example, a party that is long an underlying instrument such as an equity can write a covered Call against their position in the underlying and use the premium proceeds to pay for their position in a Win, Lose or Draw contract involving the same underlying. So, referencing the original example, if Party A were long 100 shares of XYZ at $25 per share and wrote a one-contact June expiration Call at a $30 strike price that carried a $1 premium, the one contract would yield Party A a $100 premium, which he could then use to pay for a $100 Win, Lose or Draw position that $30 per share will occur before $22½ per share for the same June expiry. If XYZ reached $30 per share before $22½ per share, then his position in the underlying would likely be called away, but in addition to his $100 premium from writing the Call, he would also earn $200 on his Win, Lose or Draw position since a payoff on that scenario is 2:1, effectively tripling his premium to $300. If XYZ reached $22½ before $30 per share, he would retain his position in the underlying (assuming it did not do an about-face and reach $30 per share after reaching $22½), but lose the $100 Win, Lose or Draw contract, which would be offset by the $100 premium he made when he wrote the Call for the underlying. If neither $30 per share nor $22½ per share occurred by expiry, then he would keep his position in the underlying as well as his $100 premium for writing the Call, and the Win, Lose or Draw contract would be a draw.

Exchanges can generate revenue by making a market for Win, Lose or Draw contracts as well as by charging brokers and dealers for processing Win, Lose or Draw contracts. A master license would also allow an exchange to generate revenue by charging brokers and dealers for the right to offer Win, Lose or Draw contracts, either as a straight-out fee or licensing right or as a percentage of the trading transaction fees generated by brokerage houses from their retail and/or institutional clients, and for providing clearing house services. Brokerages can generate revenue by charging a trade transaction fee just as they do with stocks and options trades. Clearing houses can generate revenue by charging clearing house fees.

Yet another way that exchanges, brokerages, and clearing houses can generate revenue is to retain a small percentage of the payoff on successful contract positions as a fee in lieu of charging traders a trade transaction fee. So, for example, if a party received a $200 net return on a successful Win, Lose or Draw position, and a fee of 1% was excised on the net return, then instead of a payoff of $200, the party would receive $198 and the brokerage, exchange and clearing house can share the $2 proceeds.

It is to be understood that the embodiments shown and described herein are merely illustrative of the principles of this invention and that various modifications may be implemented by those skilled in the art without departing from the scope and spirit of the invention.

What is claimed is:

1. A computer-implemented method of defining and listing a derivative product for trading on an exchange or over-the-counter trading platform, comprising:
a) designating, by means of a programmed computer, a first price event above a reference price for a given underlying financial instrument;
b) designating, by means of a programmed computer, a second price event below the reference price for the given underlying financial instrument;
c) designating, by means of a programmed computer, a common time frame for either designated price event to occur; and
d) designating, by means of a programmed computer, predetermined payoffs, wherein:
i) a first predetermined payoff is based at least in part on the occurrence of the first designated price event at the expiration of the designated time frame versus the occurrence of the second designated price event at the expiration of the designated time frame; and
ii) a second predetermined payoff is based at least in part on the occurrence of the second designated price event at the expiration of the designated time frame versus the occurrence of the first designated price event at the expiration of the designated time frame.

2. The computer-implemented method of claim 1, wherein the given underlying financial instrument is defined as a single-stock equity, equity index, bond, bond index, mutual fund, exchange-traded fund, single-stock future, equity index future, volatility index, interest rate, interest rate index, commodity, commodity future, commodity index future, currency, currency index, currency future or currency index future.

3. The computer-implemented method of claim 1, wherein the reference price for the given underlying financial instrument is defined as the spot price or any contingent future price for the underlying financial instrument.

4. The computer-implemented method of claim 3, wherein the spot price for the given underlying financial instrument is defined as the current market price or any suitable quoted or posted price for the underlying financial instrument at any given point in time.

5. The computer-implemented method of claim 1, wherein the first price event comprises an exact price above the reference price for the underlying financial instrument or any price above the exact price.

6. The computer-implemented method of claim 1, wherein the first price event comprises any price within a specified price range above the reference price for the underlying financial instrument.

7. The computer-implemented method of claim 1, wherein the second price event comprises an exact price below the reference price for the underlying financial instrument or any price below the exact price.

8. The computer-implemented method of claim 1, wherein the second price event comprises any price within a specified price range below the reference price for the underlying financial instrument.

9. A computer-implemented method of executing a derivative contract between two parties, comprising:
a) receiving and processing, by means of a programmed computer, a first order on behalf of a first party for a first cash or asset-backed position, the first position comprising parameters including at least a first predetermined payoff based at least in part on the occurrence of a first designated price event above a reference price for a given underlying financial instrument at the expiration of a predetermined time frame versus the occurrence of a second designated price event below the reference price for the given underlying financial instrument at the expiration of the predetermined time frame;
b) receiving and processing, by means of a programmed computer, a second order on behalf of a second party for a second cash or asset-backed position, the second position comprising parameters including at least a second predetermined payoff based at least in part on the occurrence of the second designated price event below the reference price for the given underlying financial instrument at the expiration of the predetermined time frame versus the occurrence of the first designated price event above the reference price for the given underlying financial instrument at the expiration of the predetermined time frame;
c) matching and processing, by means of a programmed computer, the first and second orders into a contract between the two parties; and
d) determining the outcome and settling the contract between the two respective parties, by means of a programmed computer, wherein:
i) the contract is settled in the first party's favor by means of at least the first predetermined payoff if the first designated price event occurs at the expiration of the predetermined time frame;
ii) the contract is settled in the second party's favor by means of at least the second predetermined payoff if the second designated price event occurs at the expiration of the predetermined time frame; and
iii) the contract is settled in neither party's favor if neither designated price event occurs at the expiration of the predetermined time frame.

10. The computer-implemented method of claim 9, wherein the given underlying financial instrument is defined as a single-stock equity, equity index, bond, bond index, mutual fund, exchange-traded fund, single-stock future, equity index future, volatility index, interest rate, interest rate index, commodity, commodity future, commodity index future, currency, currency index, currency future or currency index future.

11. The computer-implemented method of claim 9, wherein the reference price for the given underlying financial instrument is defined as the spot price or any future contingent price for the underlying financial instrument.

12. The computer-implemented method of claim 11, wherein the spot price for the given underlying financial instrument is defined as the current market price or any suitable quoted or posted price for the underlying financial instrument at any given point in time.

13. The computer-implemented method of claim 9, wherein the first price event comprises an exact price above the reference price for the underlying financial instrument or any price above the exact price.

14. The computer-implemented method of claim 9, wherein the first price event comprises any price within a specified price range above the reference price for the underlying financial instrument.

15. The computer-implemented method of claim 9, wherein the second price event comprises an exact price below the reference price for the underlying financial instrument or any price below the exact price.

16. The computer-implemented method of claim 9, wherein the second price event comprises any price within a specified price range below the reference price for the underlying financial instrument.

17. A programmed computer system for executing a derivative contract between two parties, comprising:
a) A computer processor operative to execute instructions from a computer program product embodied in a computer-readable medium to receive and process a first order on behalf of a first party for a first cash or asset-backed position, the first position comprising parameters including at least a first predetermined payoff based at least in part on the occurrence of a first designated price event above a reference price for a given underlying financial instrument at the expiration of a predetermined time frame versus the occurrence of a second designated price event below the reference price for the given underlying financial instrument at the expiration of the predetermined time frame;
b) A computer processor operative to execute instructions from a computer program product embodied in a computer-readable medium to receive and process a second order on behalf of a second party for a second cash or asset-backed position, the second position comprising parameters including at least a second predetermined payoff based at least in part on the occurrence of the second designated price event below the reference price for the given underlying financial instrument at the expiration of the predetermined time frame versus the occurrence of the first designated price event above the reference price for the given underlying financial instrument at the expiration of the predetermined time frame;
c) A computer processor operative to execute instructions from a computer program product embodied in a computer-readable medium to match and process the first and second orders into a contract between the two parties; and
d) A computer processor operative to execute instructions from a computer program product embodied in a computer-readable medium to determine the outcome and settle the contract between the two parties, wherein:
i) the contract is settled in the first party's favor by means of at least the first predetermined payoff if the first designated price event occurs at the expiration of the predetermined time frame;
ii) the contract is settled in the second party's favor by means of at least the second predetermined payoff if the second designated price event occurs at the expiration of the predetermined time frame; and
iii) the contract is settled in neither party's favor if neither designated price event occurs at the expiration of the predetermined time frame.

18. The system of claim 17, wherein the given underlying financial instrument is defined as a single-stock equity, equity index, bond, bond index, mutual fund, exchange-traded fund, single-stock future, equity index future, volatility index, interest rate, interest rate index, commodity, commodity future, commodity index future, currency, currency index, currency future or currency index future.

19. The system of claim 17, wherein the reference price for the given underlying financial instrument is defined as the spot price or any contingent future price for the underlying financial instrument.

20. The system of claim 19, wherein the spot price for the given underlying financial instrument is defined as the current market price or any suitable quoted or posted price for the underlying financial instrument at any given point in time.

21. The system of claim 17, wherein the first price event comprises an exact price above the reference price for the underlying financial instrument or any price above the exact price.

22. The system of claim 17, wherein the first price event comprises any price within a specified price range above the reference price for the underlying financial instrument.

23. The system of claim 17, wherein the second price event comprises an exact price below the reference price for the underlying financial instrument or any price below the exact price.

24. The system of claim 17, wherein the second price event comprises any price within a specified price range below the reference price for the underlying financial instrument.
